(19) United States
(12) Patent Application Publication
(10) Pub. No.: US 2026/0038403 A1
(43) Pub. Date: Feb. 5, 2026

(54) DISPLAY APPARATUS AND VEHICLE

(71) Applicant: Sharp Display Technology Corporation, Kameyama City (JP)

(72) Inventor: Masashi MAYUMI, Kameyama City (JP)

(21) Appl. No.: 19/276,568

(22) Filed: Jul. 22, 2025

(30) Foreign Application Priority Data
Aug. 2, 2024 (JP) 2024-128218

(51) Int. Cl. G09G 3/02; G06F 3/041; G06F 3/044

(52) U.S. Cl. CPC G09G 3/025; G06F 3/0412; G06F 3/04166; G06F 3/04184; G06F 3/0445; G06F 2203/04101; G06F 2203/04107; G09G 2310/08; G09G 2320/0233; G09G 2330/023; G09G 2354/00; G09G 2358/00; G09G 2380/10

(57) ABSTRACT

A display apparatus includes: a display panel that includes a first display region displaying a first image and a second display region displaying a second image; a light-blocking pattern that is arranged such that the first image is visible to a first user who views the display panel from a first side but the second image is invisible to the first user and such that the first image is invisible to a second user who views the display panel from a second side opposite to the first side and the second image is visible to the second user; and a proximity sensor that is of capacitance type and includes a plurality of sensor electrodes that are superimposed on the light-blocking pattern in a plan view.

### BACKGROUND

### 1. Field

The present disclosure relates to a display apparatus and a vehicle.

### 2. Description of the Related Art

Japanese Unexamined Patent Application Publication No. 2017-129630 (published Jul. 27, 2017) discloses a configuration in which a proximity sensor measures a distance between a multi-view display and a touch operator and a viewing angle is changed in accordance with position information on the touch operator such that the screen of the multi-view display is visible to only the touch operator.

The configuration disclosed in Japanese Unexamined Patent Application Publication No. 2017-129630 includes multiple proximity sensors in a frame region of a display apparatus. The configuration therefore provides a difficulty in narrowing the frame region of the display apparatus.

### SUMMARY

According to a first aspect of the disclosure, there is provided a display apparatus including: a display panel that includes a first display region displaying a first image and a second display region displaying a second image; a light-blocking pattern that is arranged such that the first image is visible to a first user who views the display panel from a first side but the second image is invisible to the first user and such that the first image is invisible to a second user who views the display panel from a second side opposite to the first side and the second image is visible to the second user; and a proximity sensor that is of capacitance type and includes a plurality of sensor electrodes that are superimposed on the light-blocking pattern in a plan view.

According to an aspect of the disclosure, there is provided a vehicle including the display apparatus according to the first aspect, wherein the first user sits in a driver's seat and the second user sits in a passenger's seat.

### BRIEF DESCRIPTION OF THE DRAWINGS

FIG. 1 is a plan view of the configuration of a display apparatus of an embodiment of the disclosure and users who view the display apparatus;

FIG. 2 is a partial cross-sectional view illustrating an example of the configuration of the display apparatus in the embodiment of the disclosure;

FIG. 3 is a functional block diagram illustrating an example of the configuration of the display apparatus in the embodiment of the disclosure;

FIG. 4 is a flow chart of an example of the control method of the display apparatus in the embodiment of the disclosure;

FIG. 5 is a timing diagram illustrating an example of drive control performed by a drive controller illustrated in FIG. 4;

FIG. 6 is a timing diagram illustrating an example of the drive control performed by the drive controller illustrated in FIG. 4;

FIG. 7 is a timing diagram illustrating an example of the drive control performed by the drive controller illustrated in FIG. 4;

FIG. 8 is a functional block diagram illustrating an example of the configuration of a display apparatus in an embodiment of the disclosure;

FIG. 9 is a functional block diagram illustrating an example of the configuration of a display apparatus in an embodiment of the disclosure;

FIG. 10 is a partial cross-sectional view illustrating an example of the configuration of a display apparatus in an embodiment of the disclosure; and

FIG. 11 is a perspective view illustrating an example of the installation of the display apparatus in an embodiment of the disclosure.

### DESCRIPTION OF THE EMBODIMENTS

### First Embodiment

### Configuration of Display Apparatus

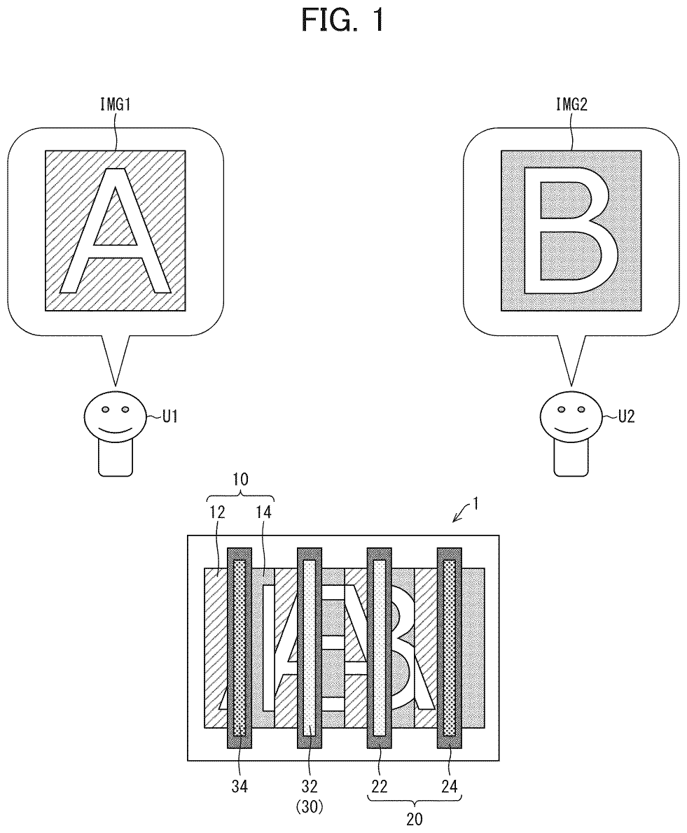

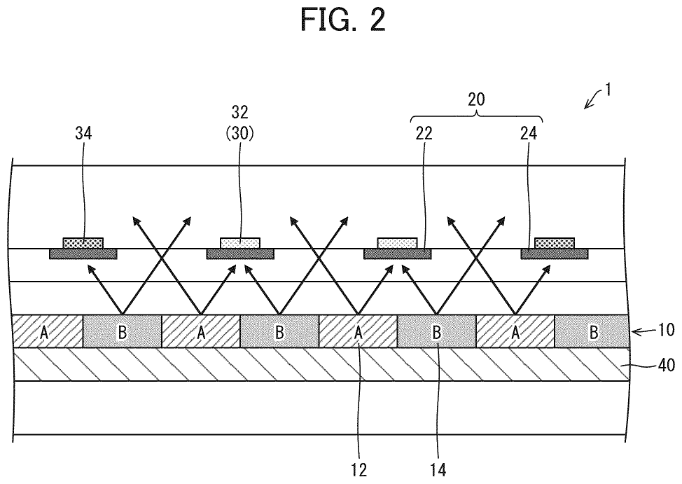

FIG. 1 is a plan view of the configuration of a display apparatus 1 of a first embodiment of the disclosure and users who view the display apparatus. FIG. 2 is a partial cross-sectional view illustrating an example of the configuration of the display apparatus 1 of the first embodiment of the disclosure. Referring to FIGS. 1 and 2, the display apparatus 1 of the first embodiment of the disclosure includes a display panel 10 that includes a first display region 12 displaying a first image IMG1 and a second display region 14 displaying a second image IMG2, a light-blocking pattern 20 that is arranged such that the first image IMG1 is visible to a first user U1 who views the display panel 10 from a first side (the left-hand side of FIG. 1) but the second image IMG2 is invisible to the first user U1 and such that the first image IMG1 is invisible to a second user U2 who views the display panel 10 from a second side (the right-hand side of FIG. 1) opposite to the first side and the second image IMG2 is visible to the second user U2; and a proximity sensor 30 that is of capacitance type and includes multiple sensor electrodes 32 that are superimposed on the light-blocking pattern 20 in a plan view.

In the configuration described above, the light-blocking pattern 20 is superimposed on a portion of the first display region 12 and a portion of the second display region 14 and the sensor electrode 32 is superimposed on the light-blocking pattern 20. The sensor electrode 32 is thus superimposed on a portion of the first display region 12 and a portion of the second display region 14. The display apparatus 1 may thus have a narrow frame portion in comparison with the configuration in which multiple proximity sensors are arranged in a frame region of a display apparatus (the configuration disclosed in Japanese Unexamined Patent Application Publication No. 2017-129630).

In the disclosure, the side (front side of FIG. 1) where the light-blocking pattern 20 is arranged with respect to the display panel 10 is referred to the front side and the side (rear side of FIG. 1) where the display panel 10 is positioned with respect to the light-blocking pattern 20 is referred to as the rear side.

The light-blocking pattern 20 includes multiple first light-blocking parts 22 and one or more second light-blocking parts 24. The sensor electrodes 32 are respectively arranged on the first light-blocking parts 22 but are not arranged on the second light-blocking parts 24. The display apparatus 1 further includes dummy electrodes 34 that are arranged on the second light-blocking parts 24 and electrically isolated.

In the configuration described above, the sensor electrode 32 is not arranged on the second light-blocking part 24 in the light-blocking pattern 20. Since the number of sensor electrodes 32 is smaller than by the number of second light-blocking parts 24, manufacturing costs of the display apparatus 1 may be reduced and computation load involved in processing detection results of the proximity sensor 30 may also be reduced.

For example, in the configuration where no dummy electrode is arranged on the second light-blocking part 24, the location where the first light-blocking part 22 and the sensor electrode 32 are present is different in terms of the light reflectance rate and/or light-absorbing rate from the location where the second light-blocking part 24 is present. Such a difference in visual characteristics of the display panel 10 degrades visual quality. In the configuration of the disclosure, however, the dummy electrode 34 is arranged on the second light-blocking part 24 and the visual quality of the display panel 10 may be relatively uniform. The relatively uniform visual characteristics may lead to an improvement in the display quality of the display apparatus 1.

If the display apparatus 1 includes a touch sensor 40, the touch sensor 40 may be arranged at a layer lower than the sensor electrode 32 and the sensor electrode 32 adversely affects the sensitivity of the touch sensor 40. In comparison with the configuration in which the sensor electrodes 32 are arranged on the entire light-blocking pattern 20, the configuration in which the second light-blocking part 24 does not have the sensor electrode 32 in the light-blocking pattern 20 may lead to an increase in the sensitivity of the touch sensor 40.

The light-blocking pattern 20 is interposed between the display panel 10 and the sensor electrodes 32 and may have a light-absorbing property. On the other hand, the sensor electrodes 32 may have a light-reflective property. The configuration in which the light-blocking pattern 20 is not present between the display panel 10 and the sensor electrodes 32 may cause the sensor electrodes 32 to reflect light, thus causing stray light. The stray light adversely affects the display quality. On the other hand, in the configuration of the embodiment of the disclosure, the light-blocking pattern 20 is interposed between the display panel 10 and the sensor electrodes 32 and has a light-absorbing property. Little or no stray light is caused by the light-reflective property of the sensor electrode 32. Little or no stray light may improve the display quality of the display apparatus 1.

The light-blocking pattern 20 may be manufactured by printing a light-absorbing material, such as black ink, on a light-transmitting substrate, such as a glass plate. The sensor electrodes 32 and the dummy electrodes 34 may be patterned metal film. The sensor electrodes 32 may be arranged at equal space intervals.

The display apparatus 1 further includes the touch sensor 40 superimposed on the display panel 10 in a plan view. The first user U1 and/or the second user U2 may operate the display apparatus 1 using the touch sensor 40. In the disclosure, a user about to operate the display apparatus 1 via the touch sensor 40 or an user operating the display apparatus 1 via the touch sensor 40 is referred to as an “operator.”

### Configuration of Controller

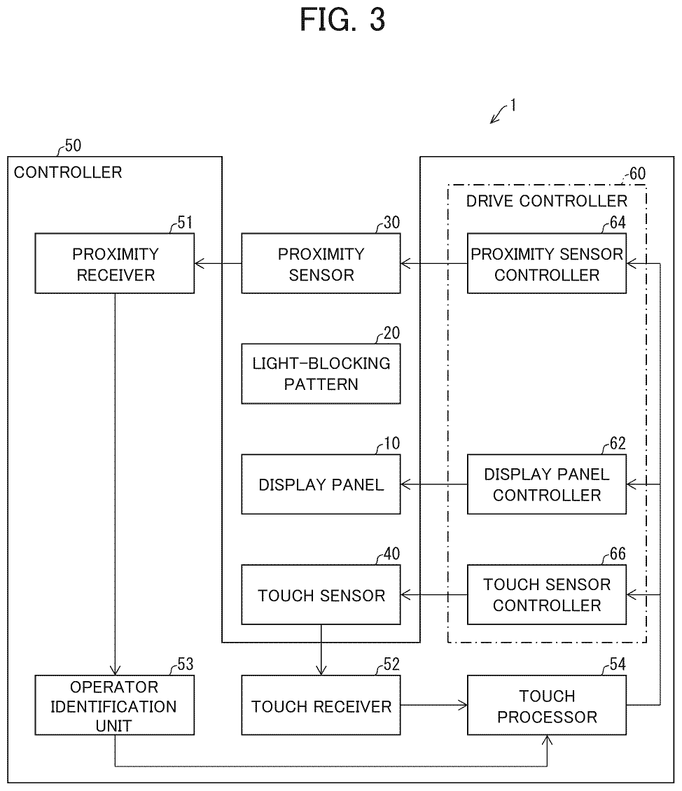

FIG. 3 is a functional block diagram illustrating an example of the configuration of the display apparatus 1 according to the first embodiment of the disclosure. Referring to FIG. 3, the display apparatus 1 according to the first embodiment of the disclosure further includes a controller 50.

The controller 50 includes a proximity receiver 51 that receives proximity information from the proximity sensor 30, a touch receiver 52 that receives touch information from the touch sensor 40, an operator identification unit 53 that identifies in accordance with the proximity information whether an operator is the first user U1 or the second user U2, and a touch processor 54 that performs a first process corresponding to the touch information if the operator is determined to be the first user U1 or a second process corresponding to the touch information if the operator is determined to be the second user U2.

In the configuration described above, the controller 50 may differentiate a touch operation performed by the first user U1 from a touch operation performed by the second user U2 and may provide the first process or the second process different from the first process depending on the operator. Furthermore, false detection of the touch sensor 40 caused by noise is not associated with the proximity information and may thus be removed.

The proximity receiver 51 may be a simple port that transmits to the operator identification unit 53 the proximity information, as is, from the proximity sensor 30 or alternatively may perform on the proximity information a process or a determination as to whether a target closer to the display apparatus 1 than a threshold is present and then transmits processed proximity information to the operator identification unit 53. The proximity receiver 51 may perform a process, such as analog-to-digital conversion on the proximity information or determination as to whether the target closer to the display apparatus 1 than the threshold is present. The proximity information may indicate a distance from each of the sensor electrodes 32 to the target, such as a hand of the operator. The locations of the sensor electrodes 32 may be recorded on a memory medium which the controller 50 is accessible to.

The operator identification unit 53 receives the proximity information from the proximity receiver 51 and identifies in accordance with the proximity information whether the operator is the first user U1 or the second user U2. The operator identification unit 53 may also identify in accordance with the proximity information whether the operator is present. The operator identification unit 53 transmits operator information indicating the operator to the touch processor 54.

The touch receiver 52 may be a simple port that transmits to the touch processor 54 the touch information, as is, from the touch sensor 40 or may perform any process on the touch information and then transmit the processed touch information to the touch processor 54. The touch information may indicate the position of the display apparatus 1 where the operator has touched.

The touch processor 54 determines in accordance with the operator information from the operator identification unit 53 whether the operator is the first user U1 or the second user U2. The touch processor 54 performs the first process in response to a touch operation performed by the first user U1 or the second process in response to a touch operation performed by the second user U2.

The controller 50 may include a drive controller 60 and the drive controller 60 may include a display panel controller 62 that controls the display panel 10, a proximity sensor controller 64 that controls the proximity sensor 30, and a touch sensor controller 66 that controls the touch sensor 40.

The first process and second process performed by the touch processor 54 may be different from each other in terms of command to the display panel controller 62. For example, the first process is to change the first image IMG1 but not to change the second image IMG2 while the second process is to change the second image IMG2 but not to change the first image IMG1.

The first process and second process performed by the touch processor 54 may be different from each other in terms of command to the proximity sensor controller 64. For example, the first process may be enabled to change the drive state of the proximity sensor 30 and the second process may not be enabled to change the proximity sensor 30. The proximity sensor 30 may have several drive states including a low-power mode in which the proximity sensor 30 detects a distance to the target with power consumption reduced, a high-power mode in which the proximity sensor 30 detects a distance to the target at a maximum capacity, and a standby mode in which the proximity sensor 30 substantially halts detection and waits on standby for an instruction from the controller 50.

The first process and second process performed by the touch processor 54 may be different from each other in terms of command to the touch sensor controller 66. For example, the first process may be enabled to change the sensing rate of the touch sensor 40 while the second process may not be enabled to change the sensing rate of the touch sensor 40.

The first process and second process may be different from each other in terms of command to two or more of the display panel controller 62, the proximity sensor controller 64, the touch sensor controller 66 and another apparatus such as a loudspeaker or air conditioning equipment. The first process and second process may be different from each other in terms of command to another apparatus such as a loudspeaker or air conditioning equipment.

### Process of Controller

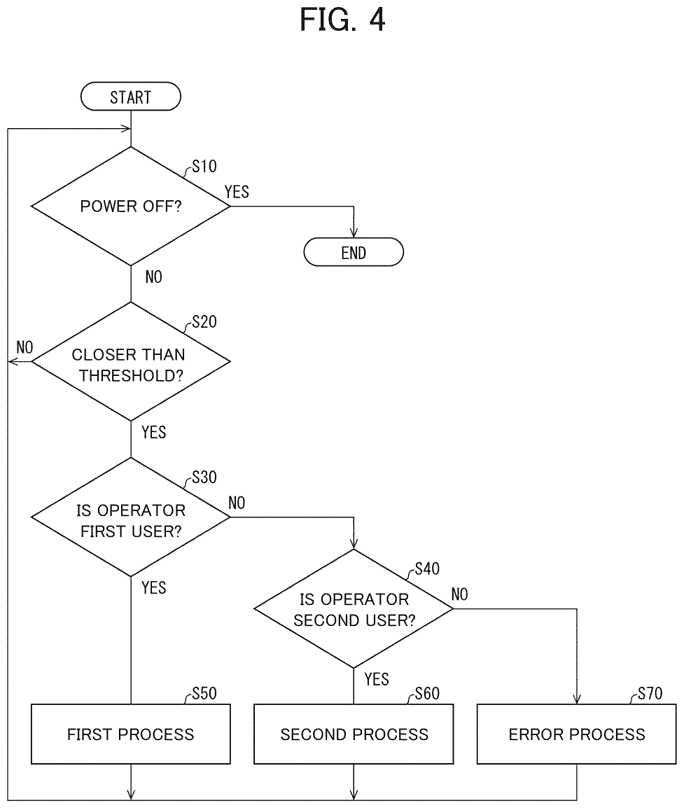

FIG. 4 is a flow chart of an example of the control method of the display apparatus 1 according to the first embodiment of the disclosure. Referring to FIG. 4, the controller 50 determines whether a power-off instruction has been provided (step S10) and if the power-off instruction has been provided (yes in step S10), the controller 50 ends the process. If the power-off instruction has not been provided (no in step S10), the proximity receiver 51 receives the proximity information from the proximity sensor 30 and the controller 50 determines the presence or absence of a target that is closer to the display apparatus 1 than a threshold (step S20). If no nearby target is present (no in step S20), the controller 50 returns to step S10.

If nearby target is present (yes in step S20), the operator identification unit 53 receives the proximity information from the proximity receiver 51 and the controller 50 determines in accordance with whether the operator is the first user U1 (step S30). If the operator is determined to be the first user U1 (yes in step S30), the touch processor 54 then receives the touch information from the touch receiver 52 and performs the first process corresponding to the touch information (step S50).

If the operator is not determined to be the first user U1 (no in step S30), the operator identification unit 53 determines in accordance with the proximity information whether the operator is determined to be the second user U2 (step S40). If the operator is determined to be the second user U2 (yes in step S40), the touch processor 54 then receives the touch information from the touch receiver 52 and performs the second process corresponding to the touch information (step S60).

If the operator is not determined to be the second user U2 (no in step S40), the touch processor 54 performs an error process (step S70). The error process may include giving a notification that a touch operation is denied because the operator is unknown.

The controller 50 returns to step S10 after step S50, S60 or S70.

### Operation Mode

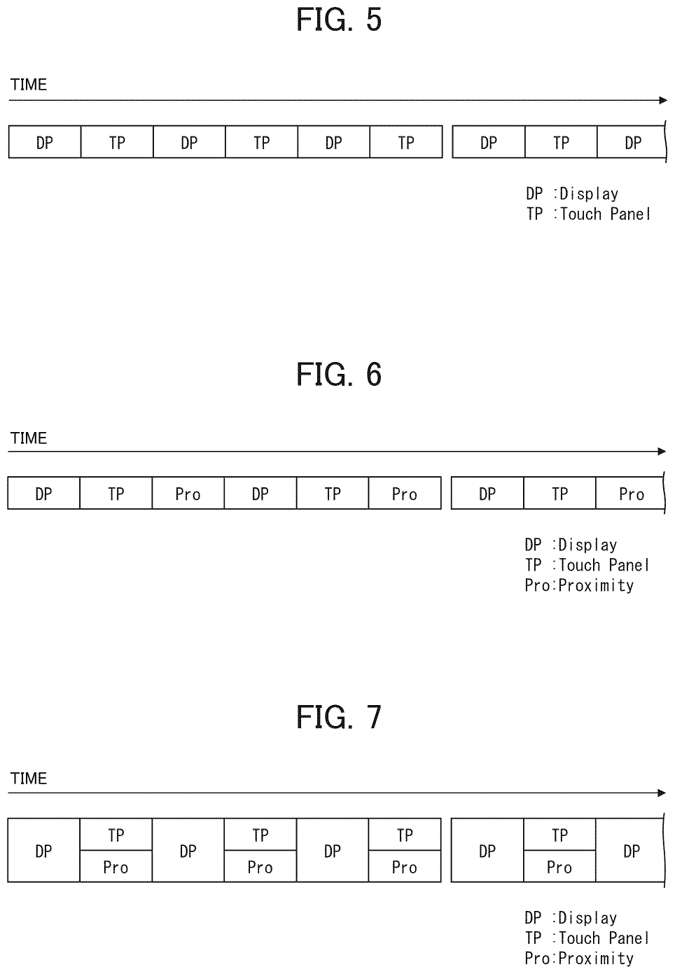

FIGS. 5 through 7 are timing diagrams illustrating examples of the drive control performed by the drive controller 60 as illustrated in FIG. 4. Referring to FIGS. 5 through 7, “DP” denotes a time duration throughout which the display panel 10 is driven, “TP” denotes a time duration throughout which the touch sensor 40 is driven, and “Pro” denotes a time duration throughout which the proximity sensor 30 is driven.

The drive controller 60 may have a first mode (i) in which the display panel 10 and the touch sensor 40 are alternatively driven and the proximity sensor 30 is not driven as illustrated in FIG. 5 and a second mode (ii) in which the display panel 10, proximity sensor 30 and touch sensor 40 are driven on a one-after-another basis as illustrated in FIG. 6. In this configuration, the drive controller 60 selectively drives one from the display panel 10 and the touch sensor 40 in the first mode and selectively drives one from the display panel 10, the proximity sensor 30 and the touch sensor 40 in the second mode. This configuration may reduce noise of the proximity sensor 30 caused by the display panel 10 and touch sensor 40 and noise of the touch sensor 40 caused by the display panel 10 and proximity sensor 30.

Since the proximity sensor 30 is not driven in the first mode, the sensing rate of the display panel 10 and the touch sensor 40 may be increased more in the first mode than in the second mode and the power consumption of the display apparatus 1 may be reduced more in the first mode than in the second mode. When the same process is performed by the first user U1 or the second user U2 who performs a touching operation, the first mode may be operative and when different processes are performed depending on the operator, the second mode may be operative.

Alternatively, the drive controller 60 may have the first mode (i) in which the display panel 10 and the touch sensor 40 are alternatively driven and the proximity sensor 30 is not driven as illustrated in FIG. 5 and a third mode (iii) in which the display panel 10 and touch sensor 40 are alternatively driven while the proximity sensor 30 and touch sensor 40 are concurrently driven as illustrated in FIG. 7. In this configuration, regardless of the first mode and third mode, the display panel 10 halts displaying when the proximity sensor 30 and touch sensor 40 are driven. The noise of the proximity sensor 30 caused by the display panel 10 may be reduced and the noise of the touch sensor 40 caused by the display panel 10 may also be reduced.

Since the proximity sensor 30 is not driven in the first mode, the power consumption of the display apparatus 1 may be reduced more in the first mode than in the third mode. For example, when the same process is performed by the first user U1 or the second user U2 who performs a touching operation, the first mode may be operative and when different processes are performed depending on the operator, the third mode may be operative.

The drive controller 60 may have the first mode, second mode and third mode.

### Second Embodiment

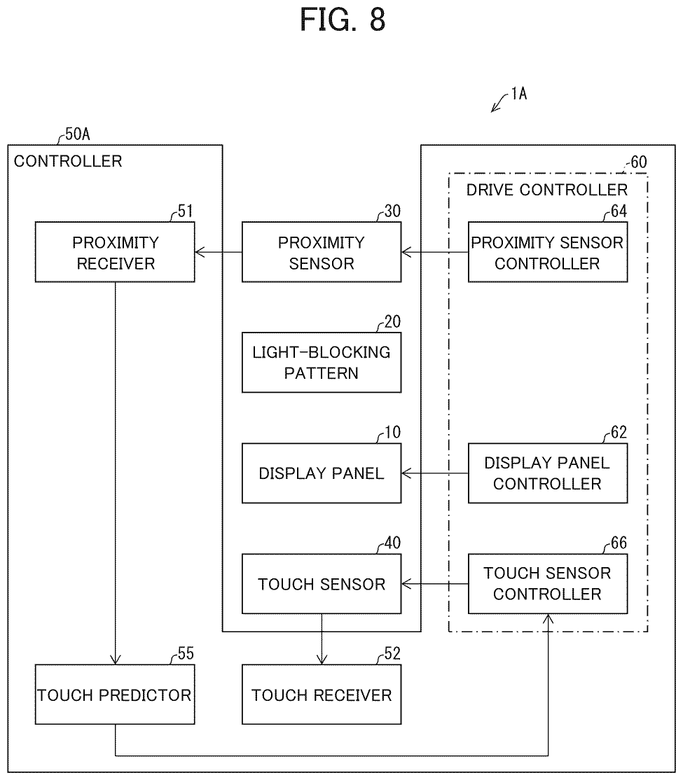

FIG. 8 is a functional block diagram illustrating an example of the configuration of a display apparatus 1A in a second embodiment of the disclosure. Referring to FIG. 8, the display apparatus 1A of the second embodiment of the disclosure includes the display panel 10, light-blocking pattern 20, proximity sensor 30, touch sensor 40, and controller 50A. The controller 50A of the second embodiment includes the proximity receiver 51 that receives the proximity information from the proximity sensor 30, touch predictor 55 that predicts a range of touch of the operator in accordance with the proximity information and touch sensor controller 66 that controls the touch sensor 40 to drive a portion of the touch sensor 40 positioned within a range predicted to be touched and to cause to be inoperative a portion of the touch sensor 40 positioned within a range predicted not to be touched.

In the configuration described above, the touch sensor controller 66 drives the portion of the touch sensor 40 positioned within the range predicted by the touch predictor 55 while causing the rest of the touch sensor 40 to be inoperative. The partially driven touch sensor 40 may reduce the power consumption of the display apparatus 1A. When the touch operation is not performed by anybody, the halting of the whole touch sensor 40 may lead to a reduction in the power consumption of the display apparatus 1A.

The configuration of the second embodiment may be combined with the configuration of the first embodiment.

### Third Embodiment

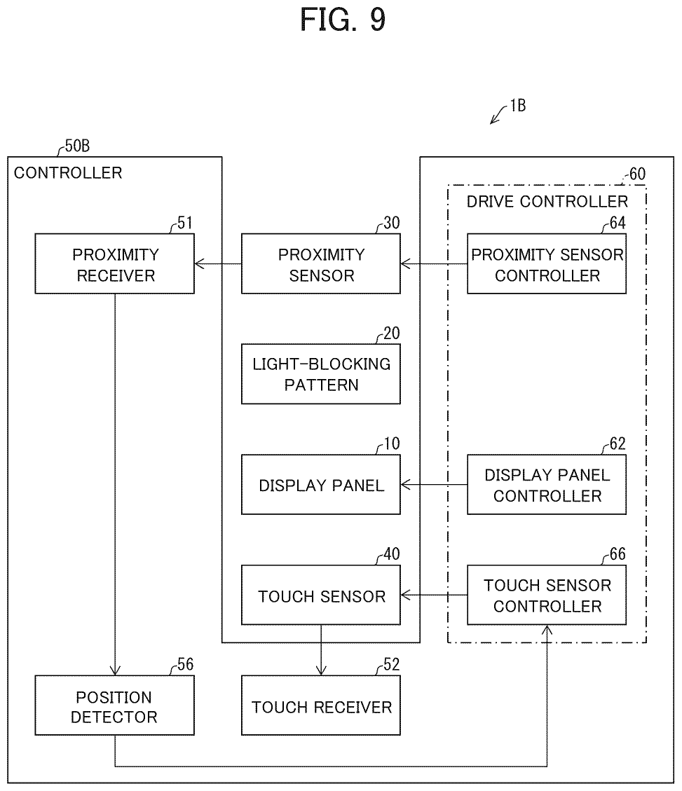

FIG. 9 is a functional block diagram illustrating an example of the configuration of a display apparatus 1B in a third embodiment of the disclosure. The display apparatus 1B of the third embodiment of the disclosure includes the display panel 10, light-blocking pattern 20, proximity sensor 30, touch sensor 40 and controller 50B. The controller 50B of the third embodiment includes the proximity receiver 51 that receives the proximity information from the proximity sensor 30, position detector 56 that detects a proximity position where the operator approaches and touch sensor controller 66 that controls the touch sensor 40 to drive the portion of the touch sensor 40 positioned within the range corresponding to the proximity position and to cause to be inoperative the portion of the touch sensor 40 positioned within the range not corresponding the proximity position.

In the configuration described above, the touch sensor controller 66 drives the portion of the touch sensor 40 positioned within the range corresponding to the proximity position detected by the position detector 56 while causing the rest of the touch sensor 40 to be inoperative. The partially driven touch sensor 40 may reduce the power consumption of the display apparatus 1B. When the touch operation is not performed by anybody, the halting of the whole touch sensor 40 may lead to a reduction in the power consumption of the display apparatus 1B.

The touch predictor 55 of the second embodiment predicts from past and/or present proximity information a range where the operator is expected to touch in the future. On the other hand, the position detector 56 of the third embodiment detects from the present proximity information the proximity position which the operator presently approaches. For this reason, the position detector 56 of the third embodiment may reduce computation load in comparison with the touch predictor 55 of the second embodiment.

The configuration of the third configuration may be combined with the configuration of the first embodiment.

### Fourth Embodiment

FIG. 10 is a partial cross-sectional view illustrating an example of the configuration of a display apparatus 1C in a fourth embodiment of the disclosure. Referring to FIG. 10, in the display apparatus 1C of the fourth embodiment, the sensor electrodes 32 may respectively arranged beneath the first light-blocking parts 22 but are not arranged beneath the second light-blocking parts 24. The dummy electrodes 34 may be arranged beneath the second light-blocking parts 24.

In the configuration described above, the sensor electrode 32 is not arranged beneath the second light-blocking part 24 in the light-blocking pattern 20. Since the number of sensor electrodes 32 is smaller than by the number of second light-blocking parts 24, the manufacturing costs of the display apparatus 1 may be reduced and the computation load involved in processing detection results of the proximity sensor 30 may also be reduced.

In the configuration where no dummy electrode is arranged beneath the second light-blocking part 24, the top shape and/or the position of the first light-blocking part 22 are different from the top shape and/or the position of the second light-blocking part 24. The top surface of each of the first light-blocking part 22 and the second light-blocking part 24 is the surface closer to the display screen of the display apparatus 1C. The difference in the top surface may adversely affect display quality. Since the dummy electrode 34 is arranged beneath the second light-blocking part 24 in the configuration described above in the disclosure, the top shape and/or the position of the light-blocking pattern 20 are substantially uniform. The substantially uniform top surface may increase display quality of the display apparatus 1.

The dummy electrode 34 may be manufactured of a non-conductive material such that the dummy electrode 34 does not affect the sensitivity of the touch sensor 40. The dummy electrode 34 may be manufactured of a light-absorbing material to reduce stray light. For example, the dummy electrode 34 may be formed by printing black ink.

The configuration of the fourth embodiment is identical to the configuration of the first embodiment except the layout of the multiple sensor electrodes 32, the layout of the one or more dummy electrodes 34 and the material of the dummy electrodes 34. The configuration of the fourth embodiment may be combined with the configurations of the second and third embodiments.

Implementation using Software

The functions of the controllers 50 through 50B in the display apparatuses 1 through 1C may be implemented by a causing a computer to function as the controllers 50 through 50B, specifically causing a computer to function as the functional blocks of the controllers 50 through 50B (such as the proximity receiver 51, touch receiver 52, operator identification unit 53, touch processor 54, touch predictor 55, position detector 56, proximity sensor controller 64, display panel controller 62 and touch sensor controller 66)

In such a case, each of the controllers 50 through 50B includes, as a hardware component to implement a program, a computer that includes at least one control device (such as a processor or a microcomputer) and at least one storage (such as a memory). The functional blocks described above in each of the embodiments may be implemented by the control device and storage that perform the program.

The program may be stored on one or more non-

transitory computer-readable recording media. The control device may or may not include a recording medium. If the control device includes no recording medium, the program may be downloaded to the control device via any wireless or wired transmission medium.

Some or all of the functions of the functional blocks may be implemented using a logic circuit. For example, an integrated circuit including the logic circuit that functions as the functional blocks falls within the scope of an embodiment of the disclosure. Furthermore, the functions of the functional blocks may be implemented using a quantum computer.

The processes described with reference to the embodiments may be implemented using artificial intelligence (AI). In such a case, AI may operate on the control device (such as a processor or a microcomputer) or on another apparatus (such as an edge computer or a cloud server).

### Fifth Embodiment

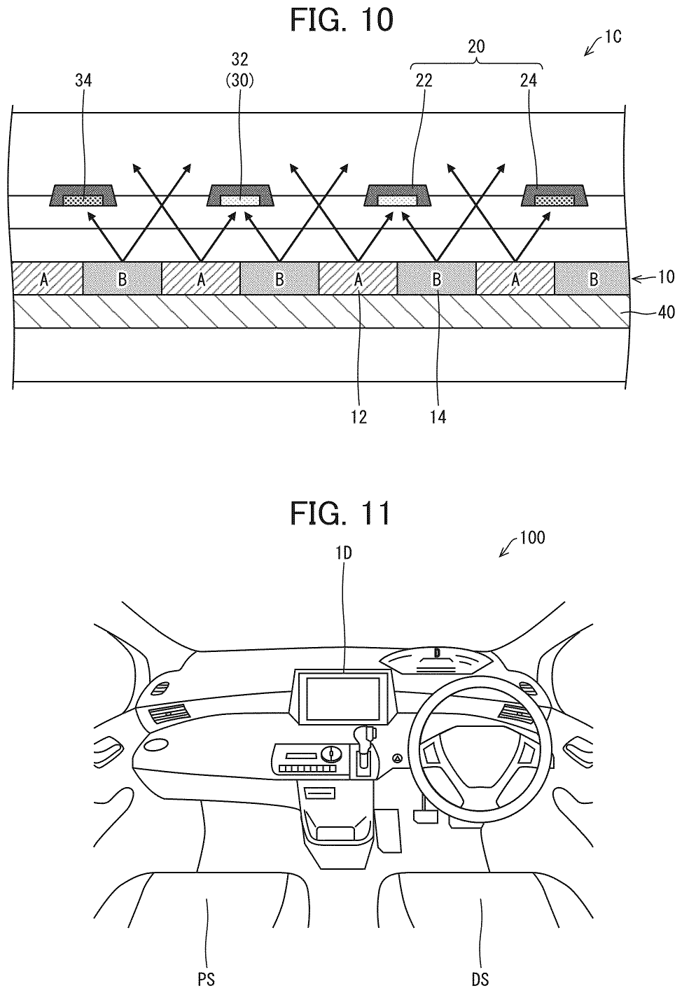

FIG. 11 is a perspective view illustrating an example of the installation of a display apparatus 1D in a fifth embodiment of the disclosure. Referring to FIG. 11, the display apparatus 1D of the fifth embodiment of the disclosure may be a vehicle display apparatus. The display apparatus 1D of the fifth embodiment may be one of the configurations of the first through fourth embodiments or a combination of two or more of the configurations or a varied form of each of the configurations. A vehicle 100 of the fifth embodiment having the display apparatus 1D mounted thereon falls within the scope of the disclosure.

The display apparatus 1D may be mounted on the vehicle 100 in view of the situation where the first user U1 sits in the driver's seat DS while the second user U2 sits in the passenger's seat PS. Alternatively, the display apparatus 1D is mounted on the vehicle 100 in view of the situation where the first user U1 sits in the passenger's seat PS while the second user U2 sits in the driver's seat DS.

### Conclusion

A display apparatus according to a first aspect of the disclosure includes: a display panel that includes a first display region displaying a first image and a second display region displaying a second image; a light-blocking pattern that is arranged such that the first image is visible to a first user who views the display panel from a first side but the second image is invisible to the first user and such that the first image is invisible to a second user who views the display panel from a second side opposite to the first side and the second image is visible to the second user; and a proximity sensor that is of capacitance type and includes a plurality of sensor electrodes that are superimposed on the light-blocking pattern in a plan view.

In the display apparatus according to a second aspect of the disclosure in view of the first aspect, the light-blocking pattern may include a plurality of first light-blocking parts and one or more second light-blocking parts, wherein the sensor electrodes are respectively arranged on the first light-blocking parts but not arranged on the one or more second light-blocking parts, and the display apparatus may further include a dummy electrode that is arranged on each of the one or more second light-blocking part and is electrically isolated.

In the display apparatus according to a third aspect of the disclosure in view of the first aspect, the light-blocking pattern may include a plurality of first light-blocking parts and one or more second light-blocking parts, wherein the sensor electrodes are respectively arranged beneath the first light-blocking parts but not arranged beneath the one or more second light-blocking parts, and the display apparatus may further include a dummy electrode that is arranged on each of the one or more second light-blocking part and is electrically isolated.

In the display apparatus according to a fourth aspect of the disclosure in view of one of the first and second aspects, the light-blocking pattern may be interposed between the display panel and the sensor electrodes and may have a light-absorbing property and the sensor electrodes may have a light-reflective property.

The display apparatus according to a fifth aspect in view of one of the first through fourth aspects may further include: a touch sensor and a controller, wherein the controller may include a proximity receiver that receives proximity information from the proximity sensor; a touch receiver that receives touch information from the touch sensor; an operator identification unit that identifies in accordance with the proximity information whether an operator is the first user or the second user; and a touch processor that performs a first process corresponding to the touch information if the operator is identified to be the first user or a second process corresponding to the touch information if the operator is identified to be the second user, with the second process at least partially different from the first process.

The display apparatus according to a sixth aspect of the disclosure in view of one of the first through fourth aspects may further include: a touch sensor and a controller, wherein the controller may include a proximity receiver that receives proximity information from the proximity sensor; a touch predictor that predicts a range where an operator touches; and a touch sensor controller that controls the touch sensor to drive a portion of the touch sensor positioned within a range predicted to be touched and to cause to be inoperative a portion of the touch sensor within a range predicted not to be touched.

In the display apparatus according to a seventh aspect of the disclosure in view of the fifth aspect, the controller may include a touch predictor that predicts in accordance with the proximity information a range where an operator touches; and a touch sensor controller that controls the touch sensor to drive a portion of the touch sensor positioned within a range predicted to be touched and to cause to be inoperative a portion of the touch sensor within a range predicted not to be touched.

The display apparatus according to an eighth aspect of the disclosure in view of one of the first through fourth aspects may further include: a touch sensor and a controller, wherein the controller may include a proximity receiver that receives proximity information from the proximity sensor; a position detector that detects in accordance with the proximity information a proximity position which an operator approaches; and a touch sensor controller that controls the touch sensor to drive a portion of the touch sensor positioned within a range corresponding to the proximity position and to cause to be inoperative a portion of the touch sensor positioned within a range not corresponding to the proximity position.

In the display apparatus according to a ninth aspect of the disclosure in view of the fifth aspect, the controller may include a position detector that detects in accordance with the proximity information a proximity position which an operator approaches; and a touch sensor controller that controls the touch sensor to drive a portion of the touch sensor positioned within a range corresponding to the proximity position and to cause to be inoperative a portion of the touch sensor positioned within a range not corresponding to the proximity position.

The display apparatus according to a tenth aspect of the disclosure in view of one of the first through fourth aspects may further include a touch sensor and a controller, wherein the controller may include a drive controller that has a first mode (i) that drives alternately the display panel and the touch sensor but does not drive the proximity sensor and a second mode (ii) that drives the display panel, the proximity sensor and the touch sensor on a one-after-another basis.

In the display apparatus according to an eleventh aspect of the disclosure in view of one of the fifth through ninth aspects, the controller may include a drive controller that has a first mode (i) that drives alternately the display panel and the touch sensor but does not drive the proximity sensor and a second mode (ii) that drives the display panel, the proximity sensor and the touch sensor on a one-after-another basis. The drive controller may include a touch sensor controller.

The display apparatus according to a twelfth aspect of the disclosure in view of one of the first through fourth aspects may further include a touch sensor and a controller, wherein the controller may include a drive controller that has a first mode (i) that drives alternately the display panel and the touch sensor but does not drive the proximity sensor and a third mode (ii) that drives alternately the display panel and the touch sensor and concurrently drives the proximity sensor and the touch sensor.

In the display apparatus according to a thirteenth aspect of the disclosure in view of one of the fifth through ninth aspects, the controller may include a drive controller that has a first mode (i) that drives alternately the display panel and the touch sensor but does not drive the proximity sensor and a third mode (ii) that drives alternately the display panel and the touch sensor and concurrently drives the proximity sensor and the touch sensor. The drive controller may include the touch sensor controller.

In the display apparatus according to a fourteenth aspect of the disclosure in view of one of the tenth and eleventh aspects, the drive controller may have a third mode (iii) that drives alternately the display panel and the touch sensor and drives concurrently the proximity sensor and the touch sensor.

The display apparatus according to a fifteenth aspect of the disclosure in view of one of the first through fourteenth aspects may be a vehicle display.

The vehicle according to a sixteenth aspect of the disclosure in view of one of the first through fifteenth aspects may be installed such that the first user sits in a driver's seat and the second user sits in a passenger's seat.

According to a seventeenth aspect of the disclosure, a control method of the display apparatus that is configured according to one of the first through fourth aspects and further includes a touch sensor includes: an operator identification step that identifies in accordance with the proximity information from the proximity sensor whether the operator is the first user or the second user; and a touch processing step that performs a first process corresponding to the touch information if the operator is identified to be the first user or a second process corresponding to the touch information if the operator is identified to be the second user, with the second process at least partially different from the first process.

According to an eighteenth aspect of the disclosure, a control method of the display apparatus that is configured according to one of the first through fourth aspects and further includes a touch sensor includes: a touch prediction step that predicts in accordance with the proximity information from the proximity sensor a range where an operator touches; and a touch sensor control step that controls the touch sensor to drive a portion of the touch sensor positioned within a range predicted to be touched and to cause to be inoperative a portion of the touch sensor within a range predicted not to be touched.

The control method of the display apparatus according to an nineteenth aspect of the disclosure in view of the seventeenth aspect may include: a touch prediction step that predicts in accordance with the proximity information from the proximity sensor a range where an operator touches; and a touch sensor control step that controls the touch sensor to drive a portion of the touch sensor positioned within a range predicted to be touched and to cause to be inoperative a portion of the touch sensor within a range predicted not to be touched.

According to a twentieth aspect of the disclosure, a control method of the display apparatus that is configured according to one of the first through fourth aspects and further includes a touch sensor includes: a position detection step that detects in accordance with the proximity information from the proximity sensor a proximity position which an operator approaches; and a touch sensor control step that controls the touch sensor to drive a portion of the touch sensor positioned within a range corresponding to the proximity position and to cause to be inoperative a portion of the touch sensor positioned within a range not corresponding to the proximity position.

The control method of the display apparatus according to a twenty-first aspect of the disclosure in view of the seventeenth aspect may include: a position detection step that detects in accordance with the proximity information from the proximity sensor a proximity position which an operator approaches; and a touch sensor control step that controls the touch sensor to drive a portion of the touch sensor positioned within a range corresponding to the proximity position and to cause to be inoperative a portion of the touch sensor positioned within a range not corresponding to the proximity position.

### Appendix

The disclosure is not limited to the embodiments described above, and a variety of changes are possible within the scope described with reference to the claims, and an embodiment obtained by combining techniques described in the different embodiments also falls within the scope of the disclosure. A new technical feature may be formed by combining the techniques disclosed in the embodiments.

The present disclosure contains subject matter related to that disclosed in Japanese Priority Patent Application JP 2024-128218 filed in the Japan Patent Office on Aug. 2, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display panel that includes a first display region displaying a first image and a second display region displaying a second image;
a light-blocking pattern that is arranged such that the first image is visible to a first user who views the display panel from a first side but the second image is invisible to the first user and such that the first image is invisible to a second user who views the display panel from a second side opposite to the first side and the second image is visible to the second user; and
a proximity sensor that is of capacitance type and includes a plurality of sensor electrodes that are superimposed on the light-blocking pattern in a plan view.

2. The display apparatus according to claim 1,
wherein the light-blocking pattern comprises a plurality of first light-blocking parts and one or more second light-blocking parts,
wherein the sensor electrodes are respectively arranged on the first light-blocking parts but not arranged on the one or more second light-blocking parts, and
wherein the display apparatus further includes a dummy electrode that is arranged on each of the one or more second light-blocking part and is electrically isolated.

3. The display apparatus according to claim 1,
wherein the light-blocking pattern is interposed between the display panel and the sensor electrodes and has a light-absorbing property, and
wherein the sensor electrodes have a light-reflective property.

4. The display apparatus according to claim 1 further comprising:
a touch sensor and a controller,
wherein the controller includes:
a proximity receiver that receives proximity information from the proximity sensor;
a touch receiver that receives touch information from the touch sensor;
an operator identification unit that identifies in accordance with the proximity information whether an operator is the first user or the second user; and
a touch processor that performs a first process corresponding to the touch information if the operator is identified to be the first user or a second process corresponding to the touch information if the operator is identified to be the second user, with the second process at least partially different from the first process.

5. The display apparatus according to claim 1 further comprising:
a touch sensor and a controller,
wherein the controller includes:
a proximity receiver that receives proximity information from the proximity sensor; a touch predictor that predicts a range where an operator touches; and
a touch sensor controller that controls the touch sensor to drive a portion of the touch sensor positioned within a range predicted to be touched and to cause to be inoperative a portion of the touch sensor within a range predicted not to be touched.

6. The display apparatus according to claim 1 further comprising:
a touch sensor and a controller,
wherein the controller includes:
a proximity receiver that receives proximity information from the proximity sensor;
a position detector that detects a proximity position which an operator approaches; and
a touch sensor controller that controls the touch sensor to drive a portion of the touch sensor positioned within a range corresponding to the proximity position and to cause to be inoperative a portion of the touch sensor positioned within a range not corresponding to the proximity position.

7. The display apparatus according to claim 1 further comprising:
a touch sensor and a controller,
wherein the controller includes a drive controller that has a first mode (i) that drives alternately the display panel and the touch sensor but does not drive the proximity sensor and a second mode (ii) that drives the display panel, the proximity sensor and the touch sensor on a one-after-another basis.

8. The display apparatus according to claim 1 further comprising:
a touch sensor and a controller,
wherein the controller includes a drive controller that has a first mode (i) that drives alternately the display panel and the touch sensor but does not drive the proximity sensor and a third mode (ii) that drives alternately the display panel and the touch sensor and concurrently drives the proximity sensor and the touch sensor.

9. The display apparatus according to claim 1 being a vehicle display.

10. A vehicle comprising the display apparatus according to claim 1, wherein the first user sits in a driver's seat and the second user sits in a passenger's seat.
